(19) United States
(12) Patent Application Publication
(10) Pub. No.: US 2022/0129821 A1
(43) Pub. Date: Apr. 28, 2022

(54) RETAIL TRAFFIC ANALYSIS STATISTICS TO ACTIONABLE INTELLIGENCE

(71) Applicant: VERINT SYSTEMS LTD., Herzliya Pituach (IL)

(72) Inventors: Oren Golan, Or-Yehuda (IL); Gadi Zimerman, Hod-Hasharon (IL); Zvi Figov, Modiin (IL); Ofer Waisman, Hadera (IL); Elad Falckovitch, Givat Shmuel (IL); Doron Yankovitch, Lapid (IL)

(21) Appl. No.: 17/346,531

(22) Filed: Jun. 14, 2021

Related U.S. Application Data
(63) Continuation of application No. 14/677,423, filed on Apr. 2, 2015, now abandoned.
(60) Provisional application No. 61/974,724, filed on Apr. 3, 2014.

(51) Int. Cl. G06Q 10/06

(52) U.S. Cl. CPC G06Q 10/06393

(57) ABSTRACT

Currently, systems for assessing traffic, such as retail traffic, only output counting results in numeric measures. Current systems do not assess problems and/or provide solutions to problems using traffic analysis methods or applications. The present disclosure is directed to methods, systems and media for applying retail traffic analysis statistics to provide actionable intelligence, such as solutions to particular inquiries or problems.

### CROSS-REFERENCE TO RELATED APPLICATIONS

This application is a continuation application of U.S. application Ser. No. 14/677,423, filed Apr. 2, 2015, which claims priority to U.S. Provisional Patent Application No. 61/974,724, filed Apr. 3, 2014, entitled “Retail Traffic Analysis Statistics to Actionable Intelligence,” which is incorporated herein by reference in its entirety

### BACKGROUND OF THE INVENTION

Video systems are often used in security, surveillance, and monitoring applications. In these applications, video is often used to count and identify people entering and exiting an area, such as a store. This information may be used to determine the number and amount of time people are in the area, among other statistics and information. Currently, systems for assessing traffic, such as retail traffic, only output counting results in numeric measures. Current systems do not assess problems and/or provide solutions to problems using traffic analysis methods or applications.

### SUMMARY OF THE INVENTION

In accordance with the present disclosure, example systems, media, and methods of generating traffic intelligence, based in part on retail traffic analysis statistics, are disclosed herein. An example method includes receiving monitoring input at a central processing unit from a plurality of sources regarding traffic or actions in a retail environment. The plurality of sources can include, for example, cameras, cashier input, transaction records, and store layout information. The example method further includes generating and storing, by the central processing unit, traffic data. The traffic data being generated, for example, by analyzing the received monitoring input to produce data/results and one or more heat/path maps. The data/results including, for example, statistical information about traffic through an area of a retail store.

The example method further includes assessing, by the central processing unit, the generated traffic data with respect to defined goals and defined key performance indicators. The example method further includes generating, by the central processing unit, a goal accomplishment status for each of the defined goals and a key performance indicator measurement for each of the key performance indicators. The example method further includes generating and outputting, by the central processing unit, action items based on the goal accomplishment statuses and the key performance indicator measurements. The action items including, for example, the key performance indicator measurements and information regarding whether the goals have been met or whether positive or negative progress has been made towards the goals.

It should be understood that the above-described subject matter may also be implemented as a computer-controller apparatus, a computer process, a computing system, or an article of manufacture, such as a computer-readable storage medium.

Other systems, methods, features, and/or advantages will be or may become apparent to one having ordinary skill in the art upon examination of the following drawings and detailed description. It is intended that all such additional systems, methods, features and/or advantages be included within this description and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designated corresponding parts throughout the several views.

FIG. 1 illustrates an exemplary embodiment of a traffic intelligence system.

FIG. 2 illustrates another exemplary embodiment of a traffic intelligence system.

FIG. 3A illustrates an exemplary embodiment of a traffic intelligence method.

FIG. 3B illustrates another exemplary embodiment of a traffic intelligence method.

FIG. 4 illustrates an exemplary embodiment of a system for creating and providing traffic intelligence.

### DETAILED DISCLOSURE

The following description depicts specific embodiments of the invention, which teach those skilled in the art how to make and use the best mode of the invention. For the purpose of teaching inventive principles, some conventional aspects have been simplified or omitted. Those skilled in the art will appreciate variations from these embodiments that fall within the scope of the invention. Those skilled in the art will appreciate that the features described herein can be combined in various ways to form multiple embodiments and variations of the invention. As a result, the invention is not limited to the specific embodiments described below, but only by the claims and their equivalents.

Currently, systems for assessing traffic, such as retail traffic, only output counting results in numeric measures. Current systems do not assess problems and/or provide solutions to problems using traffic analysis methods or applications. Thus, the present inventors recognize that systems and methods are needed for applying retail traffic analysis statistics to provide actionable intelligence, such as solutions to particular inquiries or problems.

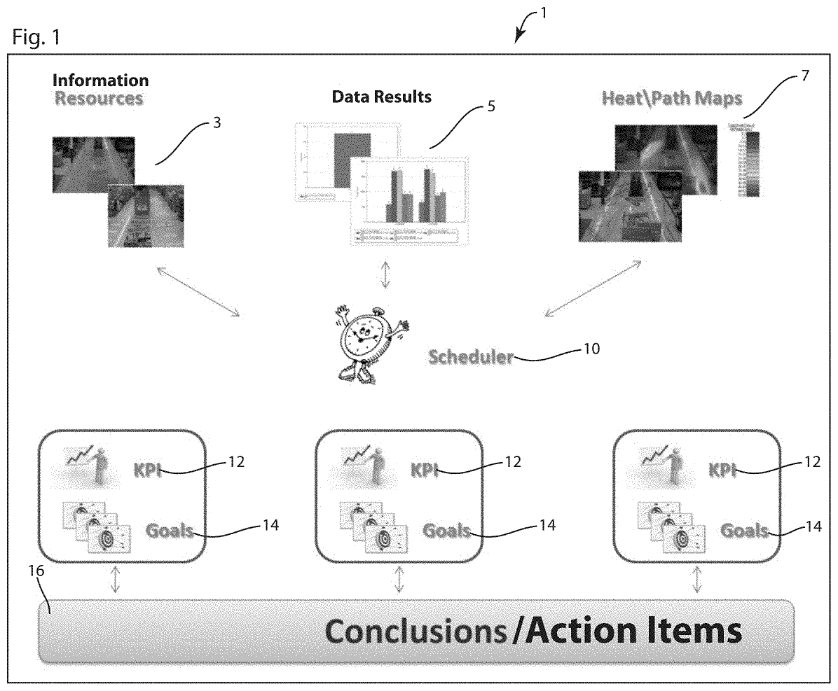

FIG. 1 illustrates one embodiment of a traffic intelligence system. The traffic intelligence system 1 starts by gathering information via resources 3. Exemplary resources may include suitable data gathering sources that provide information regarding traffic or actions in a particular environment, such as video camera recordings, people counters, cashier or checkout data, transaction records, product tracking systems, tripwires lines, queue data, directional data, store layouts, etc. The information gathered from resources 3 is then sent to the scheduler 10, which generates and analyzes the information to produce data/results 5 and one or more heat/path maps 7. The data/results 5 may include, for example, statistical information about traffic through a particular area, such as traffic numbers, stay time, purchase amounts, and statistical comparisons between traffic data and retail dollars. In a retail environment application, the data/results 5 may include statistical information correlating profits to traffic, such as comparisons between customer stay time and total receipts, traffic density and stay time, total receipts and time of day, etc.

The generated Heat/path maps 7 convey, in map, or image form, information about traffic patterns and stay times of a particular area. For example, as shown in FIG. 1, the heat/path maps 7 may be viewed from a video recording or photo image and overlaid with colored lines depicting traffic patterns of individuals. The heat/path maps 7 may convey “hot spots” where customers spend more time, which provides more opportunity for reaching that individual customer. In an alternative embodiment, the heat/path map 7 may be any map that illustrates or conveys the flow, patterns, speed, density, etc. of traffic through a defined space.

The scheduler 10 may also analyze and compare the data/results 5 and heat/path maps 7 over time, or in comparison to one another, to generate intelligence about the traffic occurring in the particular analyzed area. That intelligence may be analyzed based on certain key performance indicators (KPI) 12 and goals 14 to generate conclusion/action item 16. Such key performance indicators 12 and goals 14 may be set by a user so that the conclusion/action items 16 provide the desired intelligence to that user. Alternatively, the traffic intelligence system 1 may be designed for a particular application, such as a particular retail environment, and the KPI 12 and goals 14 may be preset according to predetermined desires and needs of such environments. In still other embodiments, the traffic intelligence system 1 may utilize algorithms or machine learning to develop KPIs and goals, which may be implemented in conjunction with user input and/or preset KPIs 12 and goals 14.

In one exemplary implementation, the traffic intelligence system 1 analyzes information resources 3 comprising video streams from surveillance cameras positioned inside a retail store or a bank branch. The scheduler 10, which may be a central processing unit or system, analyzes the video streams to produce information output regarding the location and time of every person/shopper/client in the retail store or bank branch throughout the hours of operation. Using this information, the scheduler 10 also produces heat/path maps 7 which illustrate the overall patterns of such persons/customers over the store. In the retail environment, for example, the user may use querying tools to input specific KPIs 12 regarding total receipts and profits. The user may also input goals 14 such as identifying dwell, wait or queue times, desired traffic patterns, desired stay times, etc.

Using the data/results 5 and the heat/path maps 7, the scheduler 10 calculates data regarding the input KPIs 12 and goals 14 to output the conclusion/action items 16. Conclusion/action items 16 may include, for example, the measures for the KPIs 12 and information regarding whether the goals 14 have been met and/or whether positive or negative progress has been made toward such goals 14. Furthermore, the conclusion/action items may include advice regarding steps that may be taken to improve KPIs 12 and/or to effectively reach goals 14. For example, an action item could include instructions to move certain products to different locations, rearrange products into a different organization or order, change lighting, change prices, change in-store advertisement, place more or less of certain products on the shelf, etc.

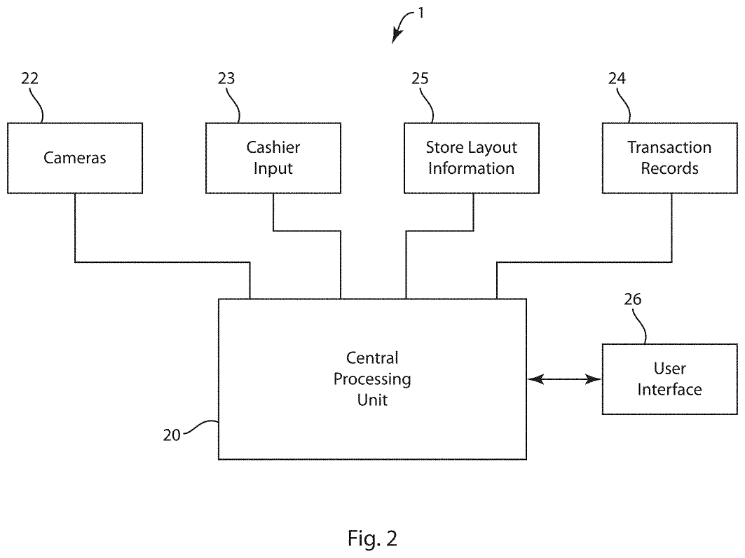

FIG. 2 demonstrates another embodiment of a traffic intelligence system 1. The traffic intelligence system 1 of FIG. 2 comprises several inputs connected to a central processing unit 20. The inputs include cameras 22, cashier input 23, transaction records 24, and store layout information 25. The central processing unit 20 is also connected to a user interface 26. The cameras 22 may include any cameras, including one or more video cameras, still cameras, infrared cameras, etc. The cameras record areas of import in the monitored area, thereby traffic patterns and traffic numbers can be monitored.

For example, the traffic intelligence system 1 of FIG. 2 is applicable to a retail environment. In such an embodiment, cashier input 23 may include data related to checkout, such as line times, number of operating cashiers, and transaction times. Likewise, transaction records 24 may include receipts or records of purchase, payment types, frequency of individual customer patronage. Store layout information 25 may include information regarding organization and layout of items within a store. Store layout information 25 may be more general, containing only item categories and general locations, or it may be more specific, containing precise locations of exact products, such as brand and product names.

The system of FIG. 2 may operate such that the central processing unit 20 receives input from a user via a user interface 26, and also outputs information to the user via the user interface 26. The user may submit a query to the central processing unit 20 which may request information, conclusions and/or action items regarding the input information received from the various inputs. The central processing unit 20 processes all of the data from the various inputs with respect to the query submitted by the user. For example, the system may output information regarding the effectiveness of the store layout contained in the store layout information 25.

The following example is an exemplary output of the central processing unit 20 to the user, for example by the user interface 26. The example demonstrates post product layout scenario where the user tests the effectiveness of the layout.

Input:
Camera scene.
Default Region-of-Interest (defines the area of maximum analysis in the scene).
Predefined Region-of-Interest (area near the default area, such as near a tested product).

Query type: People in region analysis.

Statistic Results:
People count in default Region-of-Region=300.
People count in product Region-of-Interest=20.
Regions ratio: 30%

KPI: Region-of-Interest tracks ratio in reliant to the size ratio.

Goals:
0%-20%
21%-50%
51% and above

Conclusions:
0%-20%
   Move the product to different aisle.
   Put the product in the middle of the aisle.
   Set different lighting near the product.
21%-50%
   Paint the prices in different colors.
   Change the product angle in ratio to other products.
51 and above: Fill the rest of the aisle with the same product.

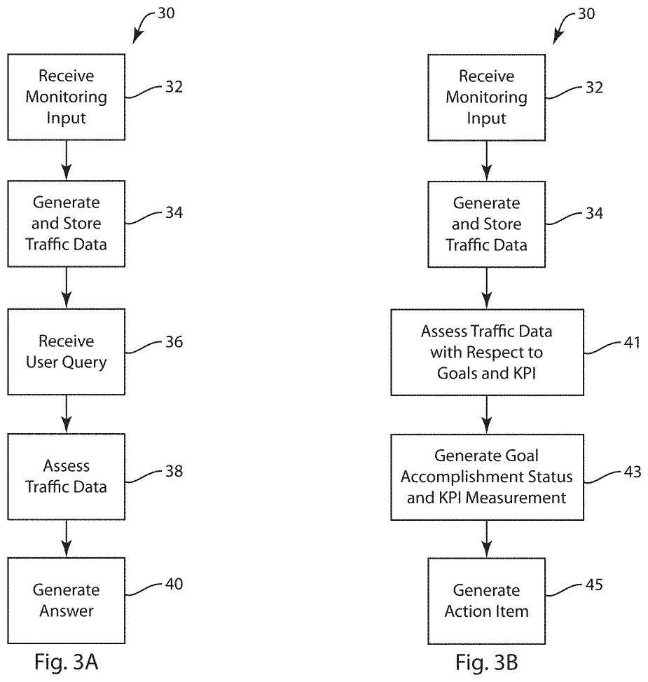

FIGS. 3A and 3B illustrate a method 30 of generating traffic intelligence. In the method 30 of FIG. 3A, monitoring input is received, for example by the various inputs demonstrated in FIGS. 1 and 2. Traffic data is then generated at step 34 based on the monitoring input. The generated traffic data is also stored, for example in a database, for later use in processing. At step 36, the user query is received. The stored traffic data is then assessed at step 38 with respect to the user query. At step 40, an answer is generated in response to the user query.

FIG. 3B illustrates another exemplary method 30 of generating traffic intelligence. Monitoring input is received at step 32, and traffic data is generated and stored at step 34. The stored traffic data is then assessed with respect to defined goals and KPIs at step 41. A goal accomplishment status for each goal and a KPI measurement for each performance indicator is then generated at step 43. Based on the goal accomplishment status and the KPIs, action items are generated, for example as described above with respect to FIGS. 1 and 2. The goals and/or KPIs may be set by a user or they may be preset as software functions for specialized software applications. Alternatively or additionally, the goals and KPIs may be continually modified by algorithms for machine learning processes such that the method and the software executing the method continually updates based on the monitoring input and the generated traffic data. The method 30 may be calculated continually in real time as traffic data is generated and stored. Alternatively or additionally, the method 30 may be executed offline based on selected data sections.

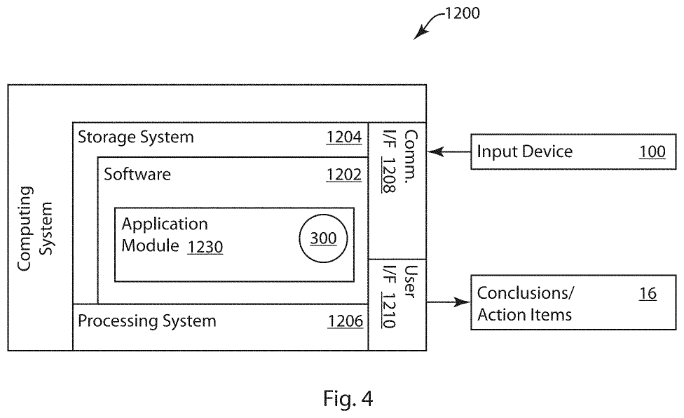

FIG. 4 is a system diagram of an exemplary embodiment of a system 1200 for creating and outputting retail traffic analysis and actionable intelligence. The retail traffic analysis module 300 may include or be broken into submodules for each analysis step disclosed herein and/or for each input device 100 or type of input device. The system 1200 is generally a computing system that includes a processing system 1206, storage system 1204, software 1202, communication interface 1208 and a user interface 1210. The processing system 1206 loads and executes software 1202 from the storage system 1204, including application module 1230. When executed by the computing system 1200, application module 1230 directs the processing system 1206 to operate as described in herein in further detail, including execution of the module 300.

Although the computing system 1200 as depicted in FIG. 4 includes one software module in the present example, it should be understood that one or more modules could provide the same operation. Similarly, while description as provided herein refers to a computing system 1200 and a processing system 1206, it is to be recognized that implementations of such systems can be performed using one or more processors, which may be communicatively connected, and such implementations are considered to be within the scope of the description.

The processing system 1206 can comprise a microprocessor and other circuitry that retrieves and executes software 1202 from storage system 1204. Processing system 1206 can be implemented within a single processing device but can also be distributed across multiple processing devices or sub-systems that cooperate in executing program instructions. Examples of processing system 1206 include general purpose central processing units, application specific processors, and logic devices, as well as any other type of processing device, combinations of processing devices, or variations thereof.

The storage system 1204 can comprise any storage media readable by processing system 1206, and capable of storing software 1202. The storage system 1204 can include volatile and non-volatile, removable and non-removable media implemented in any method or technology for storage of information, such as computer readable instructions, data structures, program modules, or other data. Storage system 1204 can be implemented as a single storage device but may also be implemented across multiple storage devices or sub-systems. Storage system 1204 can further include additional elements, such a controller, capable of communicating with the processing system 1206.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to storage the desired information and that may be accessed by an instruction execution system, as well as any combination or variation thereof, or any other type of storage medium. In some implementations, the storage media can be a non-transitory storage media. In some implementations, at least a portion of the storage media may be transitory. It should be understood that in no case is the storage media a propagated signal.

User interface 1210 can include a mouse, a keyboard, a touch screen, a voice input device, a touch input device for receiving a gesture from a user, a motion input device for detecting non-touch gestures and other motions by a user, and other comparable input devices and associated processing elements capable of receiving user input from a user. Output devices such as a video display or graphical display can display an interface further associated with embodiments of the system and method as disclosed herein. Speakers, printers, haptic devices and other types of output devices may also be included in the user interface 1210. As disclosed in detail herein, the user interface 1210 operates to allow a user to input information, such as KPIs and/or goals, and to output the conclusions/action items 16.

As described in further detail herein, the computing system 1200 receives information from an input device 100, such as the input devices described with respect to FIGS. 1 and 2. The input device 100 may be, for example, a video recording or feed. The video file may exemplarily be a .AVI file, but may also be other types of video or image files. In further embodiments, the input device 100 may be streaming video data received in real time or near-real time by the computing system 1200. In still other embodiments, the input may be any input device providing data about a monitored environment, such as a retail environment.

This written description uses examples to disclose the invention, including the best mode, and also to enable any person skilled in the art to make and use the invention. The patentable scope of the invention is designed by the claims, and may include other examples that occur to those skilled in the art. Such other examples are intended to be within the scope of the claims if they have structural elements and/or method steps that to not differ from the literal language of the claims, or if they include equivalent structural elements and/or method steps with insubstantial differences from the literal languages of the claims.

1-33. (canceled)

34. A method of modeling retail traffic in a graphical user interface, the method comprising:
providing a central processing unit communicatively coupled to the graphical user interface, and operatively connected to at least two cameras to receive data from the at least two cameras;
receiving a request at the central processing unit from a user via the graphical user interface, the request including an instruction to generate an intelligence model related to a particular physical retail environment, the request identifying a key performance indicator related to the particular physical retail environment to be analyzed;
extracting data corresponding to parameters of the key performance indicator from camera data received from the at least two cameras, the parameters including at least two of customer traffic paths, number of customers, product location, product types, line times, number of people in line, number of cashiers, transaction times and deriving traffic patterns from the video data,
wherein the at least two cameras are an infrared camera and at least one of a video camera or a still camera;
storing the extracted data in memory communicatively coupled to the central processing unit;
calculating, continually and in real time, using algorithms for machine learning processes, the key performance indicator according to the extracted data as the data is received and stored; and
presenting a visual representation of the intelligence model based on the key performance indicator to the user via the graphical user interface, wherein the user can adjust key logistical operations of the retail environment based on the visual representation.

35. The method of claim 34, wherein the visual representation includes a heat/path map conveying in map or image form, information about traffic patterns and stay times of an area of the particular physical retail environment and the key performance indicator is generated by the central processing unit at least analyzing and comparing the heat/path map to at least one prior heat/path map.

36. The method of claim 34, wherein the central processing unit is further operatively coupled to at least one of a cashier input, transactional records, and store layout information.

37. A traffic intelligence system, comprising:
a central processing unit;
a graphical user interface communicatively coupled to the central processing unit; and
a memory coupled to the central processing unit, the memory storing instructions which when executed, cause the central processing unit to perform a method comprising:
receiving a request at the central processing unit from a user via the graphical user interface, the request including an instruction to generate an intelligence model related to a particular physical retail environment, the request identifying a key performance indicator related to the particular physical retail environment to be analyzed;
extracting data corresponding to parameters of the key performance indicator from camera data received from the at least two cameras, the parameters including at least two of customer traffic paths, number of customers, product location, product types, line times, number of people in line, number of cashiers, transaction times and deriving traffic patterns from the video data,
wherein the at least two cameras are an infrared camera and at least one of a video camera or a still camera;
storing the extracted data in memory communicatively coupled to the central processing unit;
calculating, continually and in real time, using algorithms for machine learning processes, the key performance indicator according to the extracted data as the data is received and stored; and
presenting a visual representation of the intelligence model based on the key performance indicator to the user via the graphical user interface, wherein the user can adjust key logistical operations of the retail environment based on the visual representation.

38. A non-transitory computer-readable medium comprising instructions which, when executed by central processing unit, cause the central processing unit to perform a method of modeling retail traffic in a graphical user interface, the method comprising:
receiving a request at the central processing unit from a user via a graphical user interface communicatively connected to the central processing unit, the request including an instruction to generate an intelligence model related to a particular physical retail environment, the request identifying a key performance indicator related to the particular physical retail environment to be analyzed;
extracting data corresponding to parameters of the key performance indicator from camera data received from at least two cameras operatively connected to the central processing unit, the parameters including at least two of customer traffic paths, number of customers, product location, product types, line times, number of people in line, number of cashiers, transaction times and deriving traffic patterns from the video data,
wherein the at least two cameras are an infrared camera and at least one of a video camera or a still camera;
storing the extracted data in memory communicatively coupled to the central processing unit;
calculating, continually and in real time, using algorithms for machine learning processes, the key performance indicator according to the extracted data as the data is received and stored; and
presenting a visual representation of the intelligence model based on the key performance indicator to the user via the graphical user interface, wherein the user can adjust key logistical operations of the retail environment based on the visual representation.
